(19) United States
(12) Patent Application Publication
(10) Pub. No.: US 2007/0113031 A1
(43) Pub. Date: May 17, 2007

(54) Memory management system and method for storing and retrieving messages

(75) Inventors: Kevin Brown, San Rafael, CA (US); Michael Spicer, Lafayette, CA (US)

Correspondence Address: EDELL, SHAPIRO, & FINNAN, LLC, 1901 RESEARCH BOULEVARD, SUITE 400, ROCKVILLE, MD, 20850, US

(73) Assignee: International Business Machines Corporation, Armonk, NY (US)

(21) Appl. No.: 11/274,154

(22) Filed: Nov. 16, 2005

(51) Int. Cl. G06F 12/00

(52) U.S. Cl. 711/160

(57) ABSTRACT

Embodiments of the present invention provide an efficient manner to systematically remove data from a memory that has been transferred or copied to disk storage, thereby facilitating faster querying of data residing in the memory. In particular, memory containing data received from data sources is partitioned into a fixed quantity of buckets each associated with a respective time interval. The buckets represent contiguous intervals of time, where each interval is preferably of the same duration. When data arrives, the data is associated with a timestamp and placed in the appropriate bucket associated with a time interval corresponding to that timestamp. If a timestamp falls outside the range of time intervals associated with the buckets, the data corresponding to that timestamp is placed in an additional bucket. Data within the oldest bucket in memory is periodically removed to provide storage capacity for new incoming information.

### BACKGROUND OF THE INVENTION

1. Technical Field

The present invention pertains to memory management. In particular, the present invention pertains to management of information within a memory to efficiently remove old data in order to provide storage capacity for new incoming information.

2. Discussion of Related Art

Current database systems may include products to handle data streams. The product generally accepts data from one or more sources and stores, aggregates, filters and publishes messages received from those sources. Typically, a relational database is used as the backing storage system for transferring data to disk storage (e.g., hard disk drive, etc.). The product maps incoming data stream formats to the particular schema of the database employed. Users desiring to access the data being transferred to disk storage desire the fastest access possible. Since data in working memory is faster to access than data residing in disk storage, the product maintains a copy of the transferred data in working memory even after that data has been transferred to the disk storage.

However, the above approach suffers from several disadvantages. For example, one of the difficulties of the above approach includes determining when to remove the data transferred to disk storage from the working memory. The above systems provide no definitive policy, but simply remove data when the working memory becomes full until sufficient memory space is available.

### SUMMARY OF THE INVENTION

Accordingly, embodiments of the present invention include a system for managing data stored in a memory unit. The memory unit includes a storage area partitioned into a plurality of storage sections each associated with a corresponding time interval. A processing system receives data items from at least one data source and stores and manages the data items within the memory unit, wherein the data items are each associated with a corresponding time indication. The processing system includes one or more modules to store each data item in a storage section associated with a time interval corresponding to the associated time indication of that data item and to remove data items from the storage section associated with the oldest time interval in response to expiration of a predetermined time period to provide storage capacity within the memory unit for new data items. The embodiments further include a method and a program product apparatus for managing the data in the memory unit as described above.

The memory management according to an embodiment of the present invention enhances query performance for time-range queries since data for a particular time range may easily be determined by examining the time intervals associated with the buckets. Further, a present invention embodiment may track whether data in a bucket has arrived in order, or has been sorted, prior to being placed in the bucket, thereby eliminating the need to sort the data a second time. In addition, the memory management of a present invention embodiment enhances the efficiency of purging the oldest data from memory since this task may be performed by emptying the oldest bucket and providing that bucket with an updated time interval.

The above and still further features and advantages of embodiments of the present invention will become apparent upon consideration of the following detailed description thereof, particularly when taken in conjunction with the accompanying drawings wherein like reference numerals in the various figures are utilized to designate like components.

### BRIEF DESCRIPTION OF THE DRAWINGS

FIG. 1 is block diagram of a system receiving data streams from sources and employing memory management according to an embodiment of the present invention.

FIG. 2 is a diagrammatic illustration of the memory of the system of FIG. 1 including data organized in accordance with an embodiment of the present invention.

FIG. 3 is a procedural flow chart illustrating the manner in which memory is managed to remove the oldest stored data according to an embodiment of the present invention.

FIG. 4 is a procedural flow chart illustrating the manner in which a time range query is processed according to an embodiment of the present invention.

### DETAILED DESCRIPTION OF THE PREFERRED EMBODIMENTS

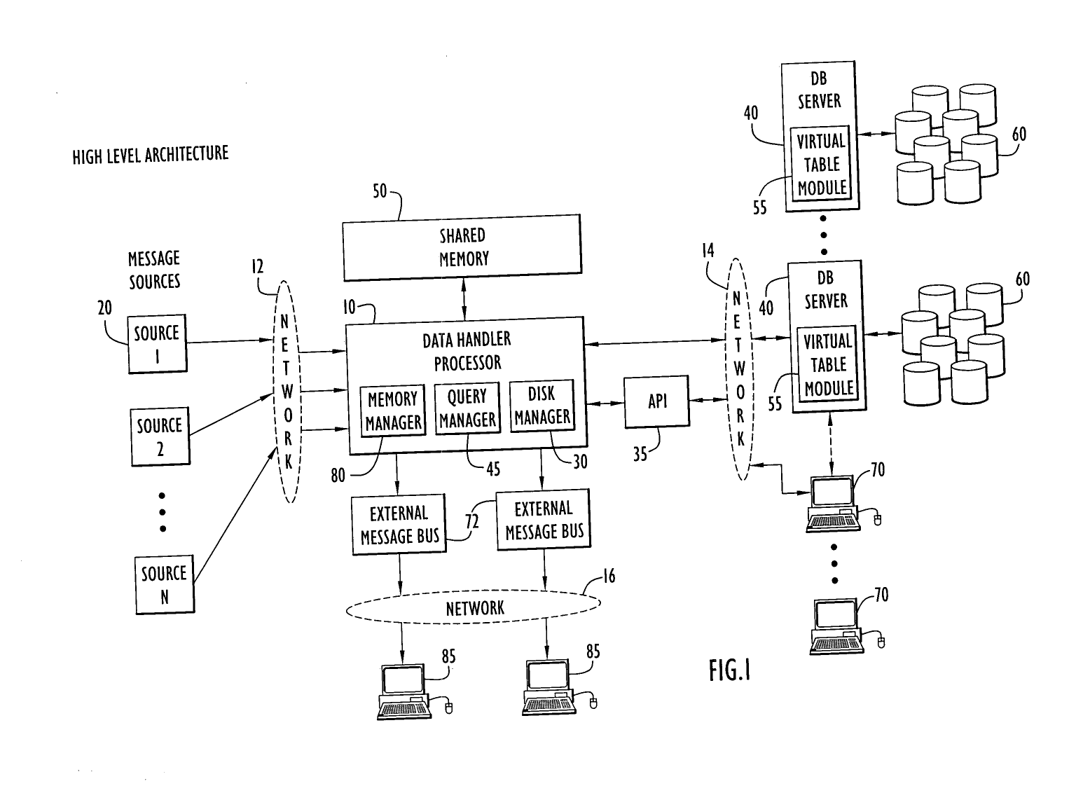

An embodiment of the present invention provides efficient memory management to manage data remaining within a memory after that data has been transferred or copied to disk storage, thereby facilitating faster querying of data. An exemplary system employing memory management according to an embodiment of the present invention is illustrated in FIG. 1. Specifically, the system includes a data handler processor 10 and associated shared or working memory 50, one or more data sources 20 providing data streams to the data handler processor in a various formats, and one or more database servers 40 each coupled to a corresponding database or disk storage 60. The data sources may provide any type of information or messages (e.g., market feeds or stock ticks, Global Positioning System (GPS) location information, Radio Frequency Identification (RFID) information for products, etc.) and may be implemented by any conventional or other devices providing data (e.g., computer systems, processors, sensors, sockets, CD/DVD, files, etc.). The data sources may be local to the data handler processor, or remote from and in communication with the data handler processor via a network 12. The network may be implemented by any quantity of any suitable communications media (e.g., WAN, LAN, Internet, Intranet, wired, wireless, etc.). The data sources may provide information in any suitable format, where the formats for each data source may vary in accordance with the data source type or information.

The data handler processor may be implemented by any conventional or other computer or processing systems preferably equipped with a display or monitor, a base (e.g., including the processor, memories and/or internal or external communications devices (e.g., modem, network cards, etc.)) and optional input devices (e.g., a keyboard, mouse or other input device). The data handler processor accepts data from one or more sources 20 and stores, aggregates, filters and publishes messages received from those sources. In particular, the data handler processor includes a disk manager module or unit 30, a query manager module or unit 45 and a memory manager module or unit 80. These components may be implemented by any combination of software and/or hardware modules or units. The memory manager module stores the received data in shared memory 50 as described below, while disk manager 30 maps various incoming data stream formats from sources 20 to the particular schema of database servers 40 and/or databases 60 for transference of the data stream to the database or disk storage as described below. Query manager unit 45 processes queries from end-user systems 70 for data within shared memory 50 and/or databases 60 as described below. The database servers may be implemented by any conventional or other computer or processing systems preferably equipped with a display or monitor, a base (e.g., including the processor, memories and/or internal or external communications devices (e.g., modem, network cards, etc.)) and optional input devices (e.g., a keyboard, mouse or other input device). The database servers are preferably utilized with relational type databases, but may be utilized with any conventional or other databases (e.g., Informix, DB2, etc.) stored in any suitable disk storage (e.g., hard disk drive or memory, etc.). The databases preferably store the data in the form of tables, where the tables may include varying record formats. However, the data may be arranged in the databases in any fashion.

One or more users or end-user systems 70 are coupled to data handler processor 10 and database servers 40 to access the data streams as described below. An Application Program Interface (API) 35 is utilized to provide access to the data handler processor. API 35 is preferably implemented in the ‘C’ and/or Java computing languages, but may be developed in any suitable computing languages. The end-user systems may communicate with the data handler processor directly to submit queries to query manager unit 45, or may submit the queries to a database server 40. The database servers include a virtual table module 55 to transfer queries received from the end-user systems to query manager unit 45 for processing as described below. The end-user systems may be implemented by any conventional or other computer systems or devices (e.g., computer terminals, personal computers, etc.) and may be local to the data handler processor and database servers, or remote from and in communication with the data handler processor and database servers via a network 14. The network may be implemented by any quantity of any suitable communications media (e.g., WAN, LAN, Internet, Intranet, wired, wireless, etc.).

In addition, data handler processor 10 may be coupled to or include external message buses 72 to provide data streams to one or more subscribers or subscriber systems 85. The message buses may be of any quantity and may be implemented by any conventional or other data transporting devices (e.g., buses, links, etc.) to relay the data stream to the subscriber systems. The subscriber systems may be implemented by any conventional or other computer systems or devices (e.g., computer terminals, personal computers, etc.) and may be local to the data handler processor and/or message buses, or remote from and in communication with the data handler processor and/or message buses via a network 16. The network may be implemented by any quantity of any suitable communications media (e.g., WAN, LAN, Internet, Intranet, wired, wireless, etc.).

Shared memory 50 may be implemented by any conventional or other memory or storage device (e.g., RAM, etc.). Since the shared memory provides faster access time than disk storage, memory manager unit 30 maintains a copy of received data in shared memory 50 after transference or copying of that data to database 60 in order to provide end-users 70 with enhanced access time to the received data. Shared memory 50 has a storage capacity less than that of database or disk storage 60 and, therefore, can only store a portion of the received data. Thus, the shared memory only stores the most recent data, where older data is removed when the shared memory becomes full to provide available storage capacity to store newly received information. The memory manager unit removes data from shared memory 50 as described below.

The data handler processor, under software control, basically implements the memory management of an embodiment of the present invention. The data handler processor may be implemented in the form of a separate processing system, or may be in the form of software modules and reside on one or more of the database servers. The software of a present invention embodiment (e.g., memory manager module, query manager module, virtual table module, disk manager module, etc.) may be available on a recordable medium (e.g., magnetic, optical, floppy, DVD, CD, etc.) or in the form of a carrier wave or signal for downloading from a source via a communication medium (e.g., bulletin board, network, WAN, LAN, Intranet, Internet, etc.).

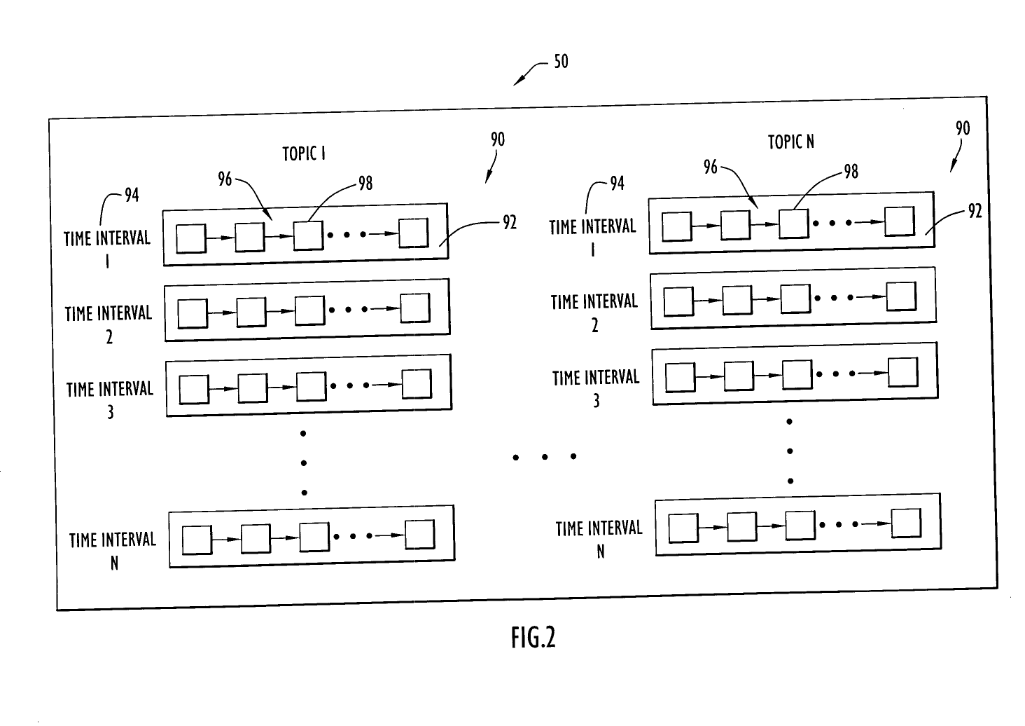

In order to efficiently remove old data from shared memory 50 for storage of newly received data, memory manager unit 30 stores the data within the shared memory in a series of buckets each associated with a corresponding time interval as illustrated in FIG. 2. Specifically, the shared memory includes one or more windows 90 each including a series of buckets 92. The buckets within each window 90 are associated with a corresponding time interval 94 (e.g., minutes, seconds, etc.). For example, a window within the shared memory may include six buckets, each associated with a time interval of ten minutes. The first bucket may be associated with the first ten minutes of a period (e.g., January 1, from 12:00 PM to 12:10:59.99999 PM), while the second bucket may be associated with the next ten minutes of the period (e.g., January 1, 12:10 PM to 12:19:59.99999 PM). The remaining buckets may similarly be associated with succeeding ten minute intervals of the period. In this case, the memory buckets may store an hour of data.

Data received by data handler processor 10 (FIG. 1) from data sources 20 includes (e.g., for historical data) or is provided with (e.g., for real-time data) a timestamp and placed in the appropriate bucket associated with a time interval encompassing the timestamp as described below. Data within each bucket is preferably stored in a linked list 96 including a series of data records 98. However, the data may be stored within a bucket via any suitable arrangement or storage structure (e.g., array, queue, stack, etc.).

The memory manager unit may utilize a single window 90, where all received data is placed in an appropriate bucket 92 of that window. Alternatively, the shared memory may include data organized in a plurality of windows 90 (e.g., as viewed in FIG. 2) each associated with a particular data characteristic (e.g., topic, subject matter, etc.). For example, each window 90 may be associated with a particular stock symbol name. In this case, the shared memory may include windows 90 each associated with a respective symbol, such as “IBM”, “MSFT”, “YHOO”, etc., where real-time data received from the data sources is provided with a timestamp and placed in the appropriate bucket within the window associated with the symbol corresponding to that data.

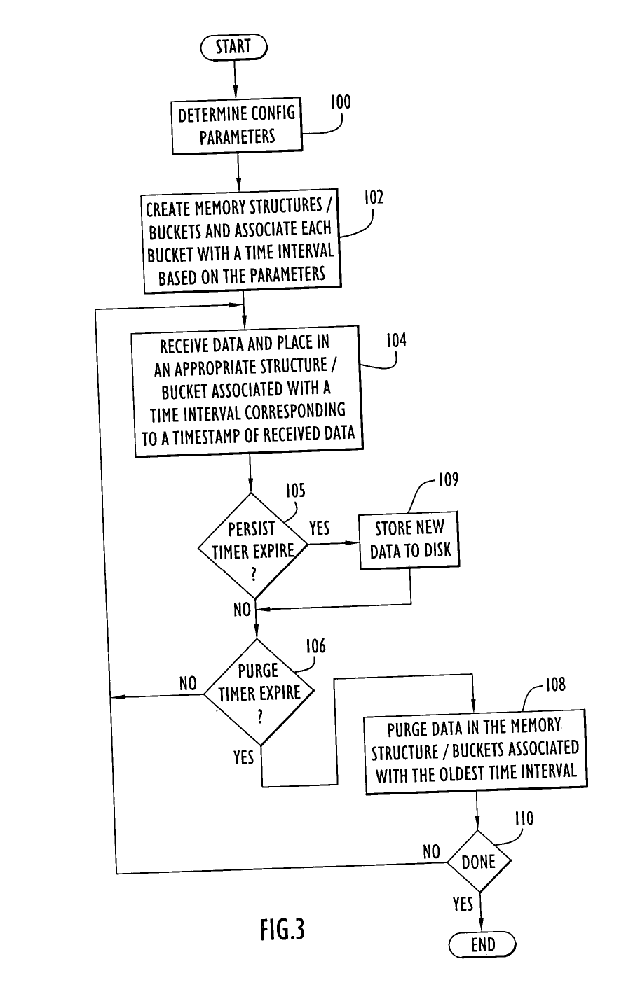

The manner in which new data is stored and old data purged within shared memory 50 according to an embodiment of the present invention is illustrated in FIG. 3. Initially, a number of configuration parameters are determined at step 100. The parameters include the quantity of windows or series of buckets, the quantity of buckets in a window, the time interval that each bucket represents, and the type of data being stored (e.g., real-time or historical data). Real-time data generally represents the data received from the data sources prior to storage (e.g., data currently generated and received from a data source in real-time), while historical data generally refers to received data that has been previously stored and associated with a timestamp (e.g., data that has been previously stored with a timestamp and is received from a data source in the form of a storage unit, such as a database or disk storage, CD/DVD, memory device, etc.). The parameters are typically stored in a configuration file that may be accessed at start-up by the data handler processor.

The memory manager unit accesses the configuration file and creates the appropriate memory structures based on the parameters at step 102. The structures include the windows, buckets and associated locks to provide read and write access to the data. A bucket includes several attributes and at a minimum includes: a timestamp to indicate the earliest data for placement in a bucket; head and tail pointers to store data within the bucket as linked list 92 (FIG. 2); pointers to indicate data in the linked list that has been transferred or copied to database or disk storage 60; an indicator to indicate that a transfer to disk memory is required; a lock structure for providing read and write locks for the bucket; and a flag to indicate whether the data in the bucket arrived in ascending timestamp order.

The quantity of buckets created for a window is two more than the quantity of buckets specified for the window at configuration time. The additional buckets are used for data that has a timestamp outside the range of the window time interval (e.g., data with a timestamp before the earliest bucket time interval or after the most recent bucket time interval), and to purge the shared memory as described below.

When a bucket is created, the head and tail pointers of linked list 92 are initialized to a NULL value, and the flag is set to zero to indicate that the data is in ascending timestamp order. The initial time for a bucket is set in accordance with the type of data to be received (e.g., real-time or historical). If real-time data is to be received, the current time may be utilized as the initial time for the first bucket. When historical data is to be received, the timestamp of the first received data is used as the initial time for the first bucket. Once the initial time for the first bucket is determined, remaining bucket start times are generated by adding the desired time interval for a bucket to the initial time for the immediately preceding bucket.

A persist timer is set to initiate transference or copying of data from shared memory 50 to database or disk storage 60 via disk manager unit 30. This timer may be set to any desired time intervals (e.g., seconds, minutes, etc.). In addition, a purge timer is initially set that expires at the end of the window time interval (e.g., the product of the quantity of buckets in the window and the length of a bucket time interval) to initiate a purge action (e.g., removal of old data from shared memory 50) as described below.

Memory manager unit 80 receives data and places the data in the appropriate bucket based on the timestamp of the received data (and/or other data characteristics (e.g., topic, subject matter, etc.) as described above) at step 104. The data timestamp may be included within the received data in the event the data stream is historical (e.g., the data has been previously stored with a timestamp and is received from a data source in the form of a storage unit, such as a database or disk storage, CD/DVD, memory device, etc.). Otherwise, the current time may serve as the timestamp for received data in response to the data stream being real-time (e.g., data currently generated and received from a data source in real-time). Initially, memory manager unit 80 receives and processes the received data and stores metadata associated with the received data in shared memory 50. The processed data may be published to subscriber systems 85 (FIG. 1) via external message buses 72 as described above.

The memory manager unit further transforms the received data from the various data source formats into an internal representation suitable for storage within an appropriate bucket in shared memory 50. Data within a bucket is preferably stored in the form of a linked list as described above, where a pointer for a bucket identifies the corresponding linked list to indicate the data within that bucket. Data may be inserted into a corresponding bucket by placing the received data within the linked list associated with that bucket. In order to prevent plural read and/or write operations from occurring simultaneously, a write lock is acquired prior to adding received data to a bucket. The write lock prevents other read and write operations from occurring on a particular bucket. Once the write lock is acquired for a desired bucket, the received data is added to the bucket. This may be accomplished by placing the received data at the end of the corresponding linked list as described above. While the write lock is in force, no other read and/or write operations may be performed on the bucket. The timestamp of the received data is compared to the timestamp of the most recent data placed in the bucket. If the timestamp of the received data is older than the timestamp of most recent data in the bucket, the flag for the bucket is set to indicate that the data in the bucket is not arranged in ascending timestamp order.

Data is received by the memory manager unit from the data sources and placed in the appropriate buckets as described above. When the persist timer expires as determined at step 105, disk manager unit 30 stores newly received data in database or disk storage 60 at step 109. In particular, disk manager unit 30 retrieves newly received data from shared memory 50 based on the data timestamps. The newly received data is basically data received within the time interval of the persist timer. The disk manager unit further retrieves or includes information pertaining to the various database servers and databases available to store the received data and determines the appropriate facility. The retrieved data is formatted to the appropriate schema for the determined database and transmitted to the corresponding database server 40 for storage in that database. The bucket containing the retrieved data is updated by the disk manager unit to indicate transference of that data to disk storage. The persist timer is reset to the desired interval as described above.

When the purge timer expires as determined at step 106, memory manager unit 80 removes data from shared memory 50 in order to have available storage capacity for more recent data. This is accomplished by removing the data from the bucket associated with the oldest time interval at step 108. In particular, a write lock is initially acquired for the oldest bucket and the entire linked list containing the data associated with that bucket is removed and placed on a free data list maintained separate from the buckets. The bucket is reinitialized with the head and tail pointers set to NULL values and the flag set to zero as described above. The initial time for the bucket is set to the next consecutive bucket time interval commencing after the time interval of the most recent bucket. The write lock is subsequently released and the bucket becomes available for reception of newly received data. The above process to remove data is repeated for the additional bucket containing data with a timestamp outside the time range of the buckets. The purge timer is reset to expire after one bucket interval as described above.

During the purge process, data is still being received and collected. An additional bucket is created as described above in order to collect data during the purging process. For example, if six buckets are specified in the configuration file, a seventh bucket is created, where six buckets store live data and one bucket is subject to the purging process. Although the purging process is performed rapidly, the process does require time. The additional bucket guarantees that the number of buckets specified in the configuration file are available for data storage even during the purging process.

The above process is repeated until occurrence of a terminating condition (e.g., power down, etc.) as determined at step 110. The above process may be performed for any quantity of windows or buckets in any fashion (e.g., sequentially, simultaneously, etc.) to remove old data from shared memory 50. For example, any quantity of buckets may be removed from any quantity of windows to provide storage capacity for newly received data.

End-user systems 70 (FIG. 1) may access the received data either prior to or subsequent storage in database 60. These systems may send a query directly to data handler processor 10 via API 35 as described above, or to a database server 40 that forwards the query to data handler processor 10 for processing. The database server includes virtual table module 55 to transfer queries received from the end-user systems to query manager unit 45 of data handler processor 10. The virtual table module includes a library of calls to the query manager unit and generally resides in the database server within a layer above the database tables. The calls are accessed in response to a query from an end-user system to transfer that query to query manager unit 45 for processing.

Query manager unit 45 of the data handler processor receives and processes queries from the end-user systems (e.g., received either directly or via database servers 40). The query manager unit retrieves or includes information pertaining to the data stored within shared memory 50 and the data stored by the various database servers and databases. The query manager unit determines the location of the requested data and retrieves the data for transmission to the requesting end-user system. The query manager unit may retrieve data from any combinations of the shared memory and database servers (and databases). For example, if the shared memory contains a portion of the requested data, the data portion is retrieved from the shared memory, while the remaining data satisfying the query is retrieved from the appropriate database servers (and databases).

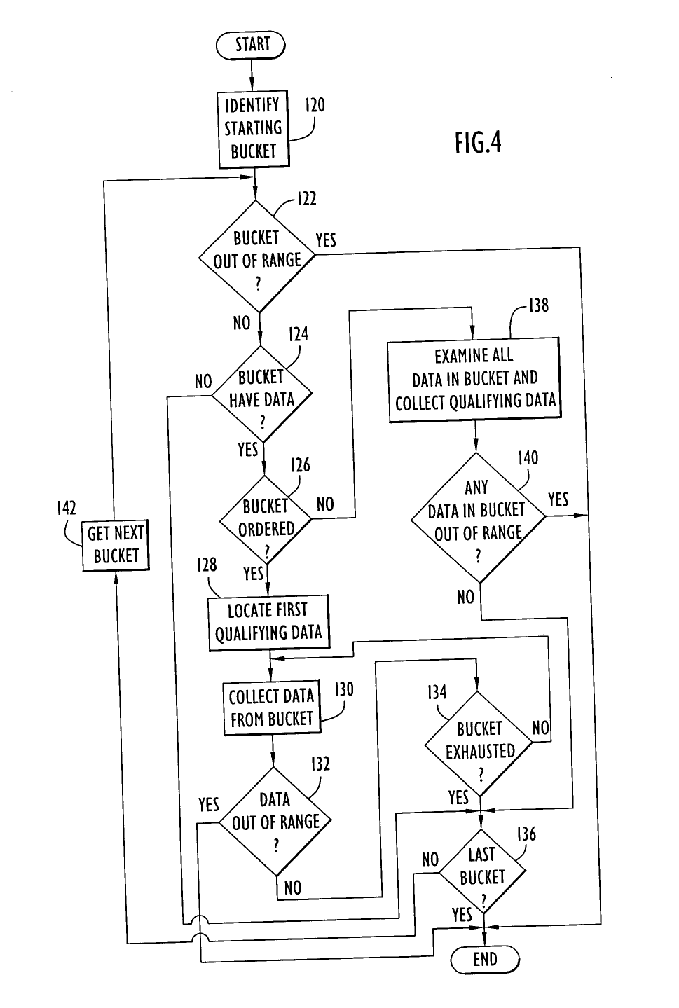

An embodiment of the present invention further improves time range query performance with respect to retrieval of information from shared memory 50. A time range query includes a qualification indicating a start time and an optional end time. In order to conventionally process this type of query, a system scans all of memory for qualifying data. However, an embodiment of the present invention is able to quickly locate qualifying data for a time range query by using the bucket arrangement described above. The manner in which a time range query may be processed according to an embodiment of the present invention is illustrated in FIG. 4. In particular, query manager unit 45 uses the start time within the query to identify the appropriate starting bucket within shared memory 50 associated with an initial time corresponding to the query start time at step 120. If the identified bucket is associated with an initial time beyond the query end time as determined at step 122, the process terminates and no data is retrieved. When the starting bucket is within the query range, but does not include data as determined at step 124, the next bucket may be retrieved for examination at step 142 in response to the presence of additional buckets as determined at step 136.

When the starting bucket is within the query range and includes data as determined at steps 122, 124, query manager unit 45 examines the data in the bucket to locate data satisfying the query. If the data within the bucket is in ascending timestamp order (e.g., indicated by the bucket flag as described above) as determined at step 126, the first qualifying data is located within the bucket at step 128. The query manager unit subsequently collects data from the bucket at step 130. Since the data is in ascending timestamp order, successive data entries may be collected from the bucket until an entry is encountered with a timestamp beyond the query end time as determined at step 132 or the bucket is exhausted as determined at step 134. If a data entry is encountered that is beyond the query end time, the process terminates since additional data entries and/or buckets that have not been examined would be associated with later timestamps and similarly be beyond the query end time.

When the data within the bucket is not in ascending timestamp order as determined at step 126, all data within the bucket is examined at step 138 to collect qualifying data. If any entry within the data bucket is beyond the query end time as determined at step 140, the process terminates since any additional buckets that have not been examined are associated with later timestamps and would similarly be beyond the query end time. When all examined data entries within the bucket are within the query end time as determined at steps 132, 134, 140 and other buckets exist as determined at step 136, the next bucket is retrieved at step 142 for processing in substantially the same manner described above. The above process is repeated until all buckets have been examined or the timestamp for a data entry or bucket is outside the range specified by the query start and end times. The collected data is subsequently transmitted to the requesting end-user system.

It will be appreciated that the embodiments described above and illustrated in the drawings represent only a few of the many ways of implementing a memory management system and method for storing and retrieving messages.

The end-user and subscriber systems employed by the present invention embodiments may be implemented by any quantity of any personal or other type of computer system (e.g., IBM-compatible, Apple, Macintosh, laptop, palm pilot, etc.), and may include any commercially available operating system (e.g., Windows, OS/2, Unix, Linux, etc.) and any commercially available or custom software (e.g., browser software, communications software, etc.). These systems may include any types of monitors and input devices (e.g., keyboard, mouse, voice recognition, etc.) to enter and/or view information.

The data handler processor and database servers may be implemented by any quantity of any personal or other type of computer system (e.g., IBM-compatible, server systems, etc.). These devices may include any commercially available operating system (e.g., Windows, Unix, Linux, etc.), any commercially available or custom software (e.g., communications software, server software, memory management software of the present invention embodiments, etc.) and any types of monitors and input devices (e.g., keyboard, mouse, voice recognition, etc.).

The databases may be implemented by any quantity of any type of conventional or other databases (e.g., relational, hierarchical, etc.) or storage structures (e.g., files, data structures, disk or other storage, etc.). The databases may store any desired information arranged in any fashion (e.g., tables, relations, hierarchy, etc.).

It is to be understood that the software (e.g., memory manager unit, query manager unit, disk manager unit, virtual table module, API, etc.) for the computer systems of the present invention embodiments (e.g., data handler processor, database servers, end-user and subscriber systems, etc.) may be implemented in any desired computer language and could be developed by one of ordinary skill in the computer arts based on the functional descriptions contained in the specification and flow charts illustrated in the drawings. By way of example only, the memory manager unit, query manager unit, disk manager unit and virtual table module may be implemented in the ‘C’ computing language, while the API may be implemented in the ‘C’ and/or Java computing languages. Further, any references herein of software performing various functions generally refer to computer systems or processors performing those functions under software control. The computer systems of the present invention embodiments may alternatively be implemented by any type of hardware and/or other processing circuitry. The various functions of the computer systems may be distributed in any manner among any quantity of software modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention may be distributed in any manner among the data handler processor, database servers and end-user systems. By way of example, the database servers may include the appropriate modules to perform the memory management described above. The software and/or algorithms described above and illustrated in the flow charts may be modified in any manner that accomplishes the functions described herein. In addition, the functions in the flow charts or description may be performed in any order that accomplishes a desired operation.

The software of the present invention embodiments may be available on a recorded medium (e.g., magnetic or optical mediums, magneto-optic mediums, floppy diskettes, CD-ROM, DVD, memory devices, etc.) for use on stand-alone systems or systems connected by a network or other communications medium, and/or may be downloaded (e.g., in the form of carrier waves, packets, etc.) to systems via a network or other communications medium.

The communication networks may be implemented by any quantity of any type of communications network (e.g., LAN, WAN, Internet, Intranet, VPN, etc.). The computer systems of the present invention embodiments (e.g., data handler processor, database servers, end-user and subscriber systems, etc.) may include any conventional or other communications devices to communicate over the networks via any conventional or other protocols. The computer systems (e.g., data handler processor, database servers, end-user and subscriber systems, etc.) may utilize any type of connection (e.g., wired, wireless, etc.) for access to the network.

The present invention embodiments may store any type of data or information within the shared memory and/or databases. The data may be historical, real-time or in any other desirable form (e.g., received or stored at any previous, current or future time). The message buses may be of any quantity and may be implemented by any conventional or other data transporting devices (e.g., buses, links, etc.) to relay the data stream to the subscriber systems.

The present invention embodiments may utilize any quantity of shared memories to store data. The memories may be implemented by any conventional or other memory or storage devices (e.g., RAM, cache, flash, etc.) and may include any suitable storage capacity. The memories may store any desired data and any information or metadata (e.g., source, location, etc.) associated with the stored data. The configuration file may be implemented by any storage structure (e.g., file, data structure, etc.) and may store any desired parameters for the present invention embodiments (e.g., timer intervals, quantity of windows and/or buckets, time intervals for buckets, etc.).

The present invention embodiments may utilize any quantity of windows, where each window may be associated with any desired attribute or characteristic of data (e.g., topic, subject matter, symbols, etc.). The windows may include any quantity of buckets, where the buckets may be associated with any desired time interval (e.g., minutes, seconds, etc.). The bucket time intervals may be uniform, or one or more buckets may be associated with different time intervals (e.g., one bucket may be associated with a ten minute interval, while another bucket may be associated with a five minute interval, etc.). The buckets may include any desired attributes or information to store and/or indicate data properties (e.g., pointers, flags, variables, etc.). The buckets may include any desired storage structures to store data (e.g., linked list, arrays, queues, stacks, etc.). The bucket flag may be of any quantity and may be set to any desired values to indicate sorted data or other conditions (e.g., bucket full, etc.). The present invention embodiments may utilize any quantity of buckets for out of range data and/or purging. The out of range data may be handled in any desired manner (e.g., deleted, provided with an appropriate timestamp, etc.).

The purge and persist timers may be of any quantity, may be implemented by any conventional or other timers or counters (e.g., hardware, software, etc.) and may indicate any desired time intervals (e.g., seconds, minutes, etc.). The timers may be set to persist and/or purge data at any desired intervals.

The present invention embodiments may remove data from any quantity of buckets within any quantity of windows to provide storage capacity for new information. For example, one bucket may be removed from a window, while two buckets may be removed from another window. One or more windows may further be associated with a corresponding purge timer to remove data from that window at a desired interval (e.g., windows may remove data at different intervals).

The present invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

From the foregoing description, it will be appreciated that the invention makes available a novel memory management system and method for storing and retrieving messages, wherein information within a memory is managed to efficiently remove old data in order to provide storage capacity for new incoming information.

Having described preferred embodiments of a new and improved a memory management system and method for storing and retrieving messages, it is believed that other modifications, variations and changes will be suggested to those skilled in the art in view of the teachings set forth herein. It is therefore to be understood that all such variations, modifications and changes are believed to fall within the scope of the present invention as defined by the appended claims.

What is claimed is:

1. A system for managing data stored in a memory comprising:
a memory unit including a storage area partitioned into a plurality of storage sections each associated with a corresponding time interval;
a processing system to receive data items from at least one data source and to store and manage said data items within said memory unit, wherein said data items are each associated with a corresponding time indication and said processing system includes:
a memory store module to store each data item in a storage section associated with a time interval corresponding to said associated time indication of that data item; and
a memory purge module to remove data items from said storage section associated with the oldest time interval in response to expiration of a predetermined time period.

2. The system of claim 1 further including:
at least one disk storage unit, wherein said processing system further includes:
a disk manager module to store data items from said memory unit in at least one disk storage unit in response to expiration of a predetermined time period.

3. The system of claim 2, wherein each disk storage unit includes a database server and an associated database with said database server in communication with said processing system, and said disk manager module includes:
a location module to determine a database server to receive a data item from said memory unit for storage in said associated database; and
a format module to format said data item in accordance with said determined database and to send said formatted data item to said determined database server for storage in said associated database.

4. The system of claim 2, wherein said processing system further includes:
a query module to receive and process a query from an end-user system in communication with said processing system and to provide data items from at least one of said memory unit and said at least one disk storage unit satisfying said query.

5. The system of claim 4, wherein each disk storage unit includes a database server and an associated database with said database server in communication with said processing system, and each database server includes:
a forward module to receive a query from an end-user system in communication with that database server and forward said query to said query module for processing.

6. The system of claim 4, wherein said query includes a time range qualification and said query module includes:
a query memory module to examine particular storage sections within said memory unit associated with time intervals satisfying said time range and to collect data items from said examined storage sections satisfying said query.

7. The system of claim 1, wherein:
said memory unit includes a plurality of said storage areas each partitioned into said plurality of storage sections with each section associated with a time interval;
said memory store module stores each data item in a storage section of one of said storage areas associated with a time interval corresponding to said associated time indication of that data item, wherein said one storage area is associated with a characteristic of that data item; and
said memory purge module removes data items from a storage section associated with the oldest time interval within at least one storage area in response to expiration of said predetermined time period to provide storage capacity within said memory unit for new data items.

8. The system of claim 1, wherein said memory unit further includes at least one memory area, and wherein:
said memory store module stores data items associated with time indications outside a range of said time intervals associated with said storage sections within said at least one memory area; and
said memory purge module removes data items from said at least one memory area in response to expiration of said predetermined time period.

9. The system of claim 1, wherein said memory unit further includes a plurality of said storage areas with at least one storage area utilized as a reserve storage area, and wherein:
said memory store module stores each newly received data item in a storage section of a reserve storage area associated with a time interval corresponding to said associated time indication of that data item in response to said memory purge module removing data items from a storage section of another storage area.

10. A method of managing data stored in a memory unit coupled to a processing system and including a storage area partitioned into a plurality of storage sections each associated with a corresponding time interval, said method comprising:
receiving data items from at least one data source, wherein said data items are each associated with a corresponding time indication;
storing, via said processing system, each data item in a storage section associated with a time interval corresponding to said associated time indication of that data item; and
removing, via said processing system, data items from said storage section associated with the oldest time interval in response to expiration of a predetermined time period.

11. The method of claim 10 further including:
storing, via said processing system, data items from said memory unit in at least one disk storage unit in response to expiration of a predetermined time period.

12. The method of claim 11, wherein each disk storage unit includes a database server and an associated database with said database server in communication with said processing system, and said storing data items in at least one disk storage unit includes:
determining a database server to receive a data item from said memory unit for storage in said associated database; and
formatting said data item in accordance with said determined database and sending said formatted data item to said determined database server for storage in said associated database.

13. The method of claim 11 further including:
receiving and processing a query from an end-user system in communication with said processing system and providing data items from at least one of said memory unit and said at least one disk storage unit satisfying said query.

14. The method of claim 13, wherein each disk storage unit includes a database server and an associated database with said database server in communication with said processing system, and said method further includes:
receiving a query at a database server from an end-user system in communication with that database server and forwarding said query to said processing system for processing.

15. The method of claim 13, wherein said query includes a time range qualification and said query processing includes:
examining particular storage sections within said memory unit associated with time intervals satisfying said time range and collecting data items from said examined storage sections satisfying said query.

16. The method of claim 10, wherein said memory unit includes a plurality of said storage areas each partitioned into said plurality of storage sections with each section associated with a time interval, and said storing each data item in a storage section includes:
storing each data item in a storage section of one of said storage areas associated with a time interval corresponding to said associated time indication of that data item, wherein said one storage area is associated with a characteristic of that data item; and
said removing data items from a storage section includes:
removing data items from a storage section associated with the oldest time interval within at least one storage area in response to expiration of said predetermined time period to provide storage capacity within said memory unit for new data items.

17. The method of claim 10, wherein said memory unit further includes at least one memory area, and said storing each data item in a storage section includes:
storing data items associated with time indications outside a range of said time intervals associated with said storage sections within said at least one memory area; and
said removing data items from a storage section includes:
removing data items from said at least one memory area in response to expiration of said predetermined time period.

18. The method of claim 10, wherein said memory unit further includes a plurality of said storage areas with at least one storage area utilized as a reserve storage area, and said storing each data item in a storage section includes:
storing each newly received data item in a storage section of a reserve storage area associated with a time interval corresponding to said associated time indication of that data item in response to removing data items from a storage section of another storage area.

19. A program product apparatus including a computer useable medium with computer program logic recorded thereon for managing data items stored in a memory unit coupled to a processing system and including a storage area partitioned into a plurality of storage sections each associated with a corresponding time interval, wherein said data items are each associated with a corresponding time indication, said program product apparatus comprising:
a memory store module to store each data item in a storage section associated with a time interval corresponding to said associated time indication of that data item; and
a memory purge module to remove data items from said storage section associated with the oldest time interval in response to expiration of a predetermined time period.

20. The apparatus of claim 19 further including:
a disk manager module to store data items from said memory unit in at least one disk storage unit in response to expiration of a predetermined time period.

21. The apparatus of claim 20, wherein each disk storage unit includes a database server and an associated database with said database server in communication with said processing system, and said disk manager module includes:
a location module to determine a database server to receive a data item from said memory unit for storage in said associated database; and
a format module to format said data item in accordance with said determined database and to send said formatted data item to said determined database server for storage in said associated database.

22. The apparatus of claim 20 further including:
a query module to receive and process a query from an end-user system in communication with said processing system and to provide data items from at least one of said memory unit and said at least one disk storage unit satisfying said query.

23. The apparatus of claim 22, wherein each disk storage unit includes a database server and an associated database with said database server in communication with said processing system, and said apparatus further includes:
a forward module for a database server to receive a query from an end-user system in communication with that database server and forward said query to said query module for processing.

24. The apparatus of claim 22, wherein said query includes a time range qualification and said query module includes:
a query memory module to examine particular storage sections within said memory unit associated with time intervals satisfying said time range and to collect data items from said examined storage sections satisfying said query.

25. The apparatus of claim 19, wherein:
said memory unit includes a plurality of said storage areas each partitioned into said plurality of storage sections with each section associated with a time interval;
said memory store module stores each data item in a storage section of one of said storage areas associated with a time interval corresponding to said associated time indication of that data item, wherein said one storage area is associated with a characteristic of that data item; and
said memory purge module removes data items from a storage section associated with the oldest time interval within at least one storage area in response to expiration of said predetermined time period to provide storage capacity within said memory unit for new data items.

26. The apparatus of claim 19, wherein said memory unit further includes at least one memory area, and wherein:
said memory store module stores data items associated with time indications outside a range of said time intervals associated with said storage sections within said at least one memory area; and
said memory purge module removes data items from said at least one memory area in response to expiration of said predetermined time period.

27. The apparatus of claim 19, wherein said memory unit further includes a plurality of said storage areas with at least one storage area utilized as a reserve storage area, and wherein:
said memory store module stores each newly received data item in a storage section of a reserve storage area associated with a time interval corresponding to said associated time indication of that data item in response to said memory purge module removing data items from a storage section of another storage area.
